(19) United States
(12) Patent Application Publication
(10) Pub. No.: US 2005/0019727 A1
(43) Pub. Date: Jan. 27, 2005

(54) Immediate load fixed-detachable dental system

(75) Inventors: Edwin McGlumphy, Columbus, OH (US); Rafael Tames, Mexico (MX); Tamer El-Gendy, Dublin, OH (US)

Correspondence Address: CALFEE, HALTER & GRISWOLD, LLP, 1110 FIFTH THIRD CENTER, 21 EAST STATE STREET, COLUMBUS, OH, 43215-4243, US

(73) Assignee: Ohio State University

(21) Appl. No.: 10/808,009

(22) Filed: Mar. 24, 2004

Related U.S. Application Data
(60) Provisional application No. 60/457,420, filed on Mar. 25, 2003.

(51) Int. Cl. A61C 8/00; A61C 3/02

(52) U.S. Cl. 433/173; 433/75

(57) ABSTRACT

A system for performing restorative dentistry on a subject. The system includes a diagnostic step which further includes the creation of a resin template for use in properly placing dental implants in a subject's jaw and a surgical step which includes placing implants in a subject's jaw and using the combination of the template and the implants to create and properly place a dental prosthetic.

### CROSS-REFERENCE TO RELATED APPLICATIONS

This patent application claims the benefit of U.S. Provisional Patent Application Ser. No. 60/457,420 filed on Mar. 25, 2003 and entitled “Immediate Load Fixed-Detachable Dental Prosthesis and Method,” the disclosure of which is incorporated by reference as if fully rewritten herein.

### STATEMENT REGARDING FEDERALLY FUNDED RESEARCH

This invention was not made by an agency of the United States Government nor under contract with an agency of the United States Government.

### TECHNICAL FIELD OF THE INVENTION

The present invention relates generally to devices and methods used in restorative dentistry and more specifically to a method that facilitates restoration of the edentulous mandible by utilizing a pattern resin framework for expediting the delivery of a final dental prosthesis.

### BACKGROUND OF THE INVENTION

Among those skilled in the art of restorative dentistry, there has recently been considerable interest in the concept of early or “immediate” loading of dental implants. The relative success of such implants and implant systems, particularly in the anterior mandible, has been documented in the scientific literature. The current surgical protocol is substantially the same for implants are loaded immediately versus those that are loaded in the typical delayed fashion, e.g., three months in the mandible and six months in the maxilla. However, to make immediate loading a reality for the patient, the restorative dentist is typically required to coordinate the activities of both the surgeon and laboratory that is fabricating the prosthesis.

Although implants in the anterior mandible can be highly successful, treatment delays remain one of the significant drawbacks to this treatment. Conventional implant therapy, which provides a fixed-detachable mandibular prosthesis, may take up to ten appointments over a four to six month time period. The desire expressed by dental patients for reducing the delays in completing restoration by means of implants has prompted research into techniques for reducing the healing time associated with known procedures. Several authors of recently published scientific articles advocate immediate loading of implants placed in the anterior mandible. Furthermore, published animal and human studies confirm that osseointegration does occur in immediately loaded implants in this region, thereby supporting the feasibility of this approach.

A patient treatment plan that includes the immediate loading of dental implants typically requires little change to standard surgical techniques. However, the restorative dentist is forced to adapt the standard protocol in order to deliver the final prosthesis quickly. Certain dental device companies in the United States have recently introduced one or more systems that address these timing difficulties. Although these systems may require additional surgical armamentarium, and may require changes in surgical protocol, it makes possible the delivery of final restoration on the same day of the implant surgery. Thus, the need exists for a method that utilizes recently developed dental system and that significantly reduces the time required for effective restorative dentistry.

### SUMMARY OF INVENTION

These and other disadvantages of the prior art are overcome by the present invention, the exemplary embodiment of which provides a system for performing restorative dentistry on a subject. This system includes a diagnostic method, which further includes the steps of: (i) taking maxillary and mandibular casts of the subject; (ii) placing a resin frame over at least one of the casts, and wherein the dimensions of the frame substantially correspond to the dimensions of at least of the casts, and wherein the frame further comprises a plurality of apertures passing through the body of the frame; (iii) creating a hole in the resin frame, wherein the location of the hole substantially corresponds to the central portion of the at least one cast; and a surgical method, which further includes the steps of (i) placing a first dental implant in the jaw the subject on which the restorative dentistry is being performed, and wherein the implant is centrally located on the jaw; (ii) securing a waxing sleeve to the first implant; (iii) placing the frame over the waxing sleeve and placing a plurality of dental implants in the subjects jaw using the apertures in the frame as a guide; (iv) removing the frame from the subjects mouth and securing waxing sleeves to the remaining implants; (v) placing the frame component back in the subject's mouth and securing the frame to the waxing sleeves to create a framework; (vi) removing the framework from the subject; (vii) casting the framework into a metal alloy; (viii) mounting a dental prosthetic to the framework; and (ix) mounting the prosthesis to the subject's jaw.

Further advantages of the present invention will become apparent to those of ordinary skill in the art upon reading and understanding the following detailed description of the preferred embodiments.

### BRIEF DESCRIPTION OF THE DRAWINGS

The accompanying drawings, which are incorporated into and form a part of the specification, schematically illustrate one or more exemplary embodiments of the invention and, together with the general description given above and detailed description of the preferred embodiments given below, serve to explain the principles of the invention.

FIG. 1 is a photograph of the frame component of the present invention modified to improve adaptation to arch form; also shown are apertures or slots that are made in the frame component for aiding in surgical placement of implants.

FIG. 2 is a photograph showing a single waxing sleeve attached to the center slot to achieve correct alignment.

FIG. 3 is a photograph showing the emplaced center implant with a waxing sleeve screwed onto the implant. The frame component of FIG. 1 is placed over the waxing sleeve at the time of surgery and is used as a surgical template.

FIG. 4 is a photograph showing substantially parallel pin implants located in osteotomy sites to facilitate implant positioning within the frame component.

FIG. 5 is a photograph showing waxing sleeves attached to each implant or abutment. At this point in the exemplary procedure, the frame component is repositioned by the restorative dentist to be parallel to the occlusal plane at the desired vertical position.

FIG. 6 is a photograph showing the attachment of laboratory analogs to the waxing sleeves following the removal or the frame component from the patient's mouth. The laboratory analogs are set in dental stone.

FIG. 7 is a photograph showing the step of making a jaw relation record after confirming the passive fit of the metal framework.

FIG. 8 is a photograph showing the final fixed-detachable prosthesis properly seated in the patient's mouth.

### DETAILED DESCRIPTION OF THE INVENTION

The exemplary embodiment of the present invention provides a system developed to overcome certain difficulties encountered by dentists working with prefabricated metal frameworks. This system facilitates restoration of the edentulous mandible and incorporates a pattern resin framework for expediting the delivery of a final prosthesis while, at the same time, providing for maximum adaptability. With this system, a definitive final restoration completed within two days may be accomplished with the active cooperation of a dental laboratory. Furthermore, little change in established and accepted surgical protocol is required and most pre-existing implant systems can be utilized with this invention. However, in contrast to systems that are currently available, no significant change in surgical armamentarium or technique is typically required. This system also allows for variability in arch form while accommodating a less than optimal surgical placement. A stepwise description of the exemplary procedure or method associated with the system of the present invention appears below.

I. Diagnostic Component

Step 1:

Maxillary and mandibular casts are mounted in the patient and the distance between the edentulous mandibular ridge and the maxillary occlusal plane is determined. This measurement should typically be at least 15 mm to provide room for the fabrication of the lower prosthesis. If 15 mm is not available, additional bone must be removed prior to placement of the implant.

Step 2:

A panoramic radiograph is taken to determine available bone height.

Step 3:

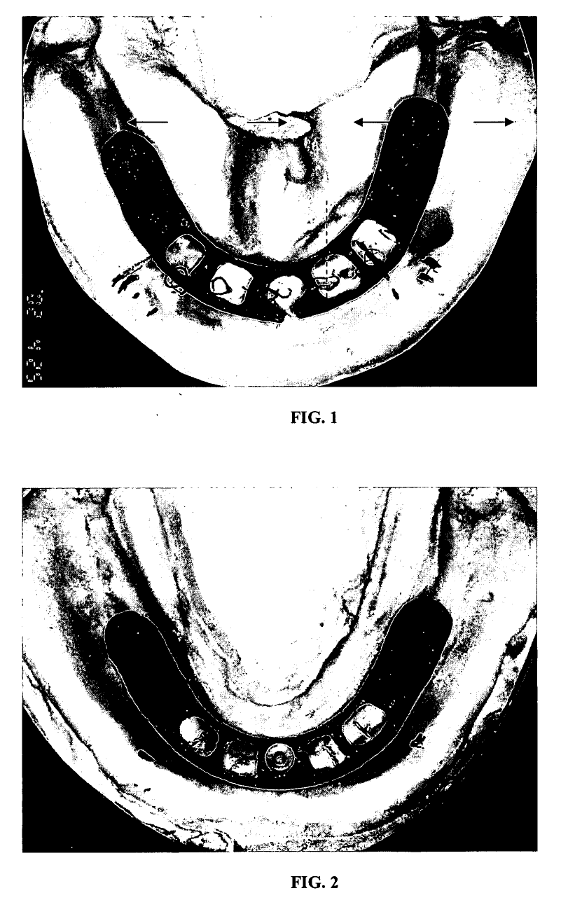

The lower cast is analyzed to determine the arch form and approximate position of the implant used in this procedure. The implants used are of the type typically used in dental procedures of this nature and may be stainless steel or a similar suitable material. The approximated implant positions are then marked on the cast (see FIG. 1).

Step 4:

The prefabricated pattern resin bar, i.e., the frame component, is positioned over the cast to verify that its shape substantially coincides with the arch form and width. If a discrepancy is noted, the frame can be modified at this time (see FIG. 1). A standard mold is typically utilized to fabricate a framework of pattern resin, and can be easily modified to accommodate different arch forms. A hole is drilled in the center of the frame component over the marked position on the cast such that it is in close contact with the plastic waxing sleeve which is utilized during the surgical procedure. Apertures or slots more loosely define the remaining implant positions (see FIG. 2).

II. Surgical Component

A. DAY ONE

Step 1:

Surgery typically starts in the morning, at 8:00 AM, for example. A standard, accepted surgical protocol for a fixed-detachable prosthesis is followed. If necessary, a ridge reduction for 15 mm of interocclusal distance is completed and the mental nerve located.

Step 2:

Using a round bur, the most distal location of the implants bilaterally and the central implant position are marked. The center implant should be placed as ideally as possible, i.e., equidistant from the distal locations.

Step 3:

The osteotomy site is prepared for the central or middle implant, and the implant is placed into position in the patient's jaw using standard dental surgical techniques.

Step 4:

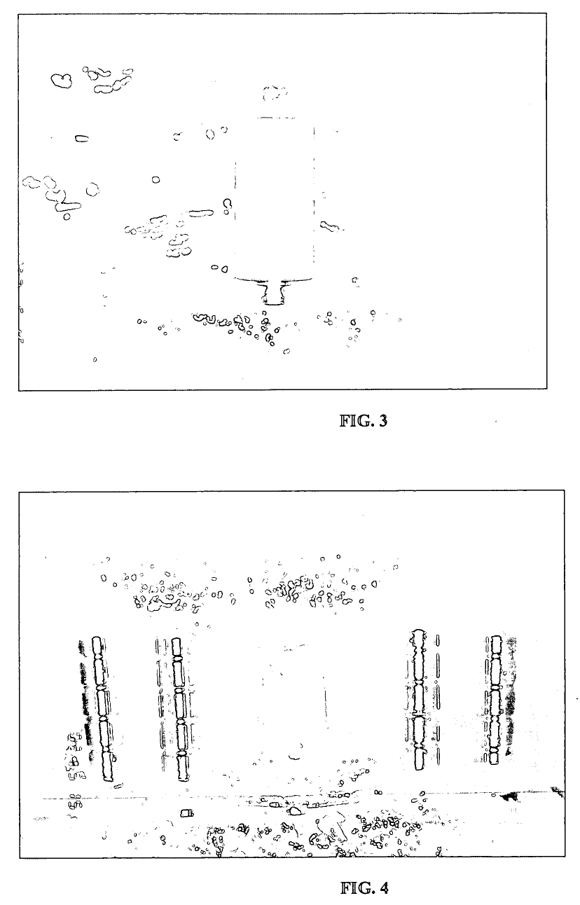

A plastic waxing sleeve is placed onto the middle implant and screwed into place (see FIG. 3).

Step 5:

The frame component is placed over the waxing sleeve (see FIG. 4). The frame component provides a resin framework, which doubles as a surgical template and casting pattern and can be modified at the time of surgery should an implant position need to be adjusted.

Step 6:

The remaining osteotomies and implants are placed in the patient's jaw utilizing the frame component as a surgical guide.

Step 7:

The frame component is removed and sutures are placed in the patient's mouth. Following this step, the restorative dentist sees the patient. Note: The time of the restorative appointment is roughly two hours (e.g. 10:00 AM) from the time the procedure commenced.

Step 8:

A waxing sleeve is placed on each implant and screwed into place.

Step 9:

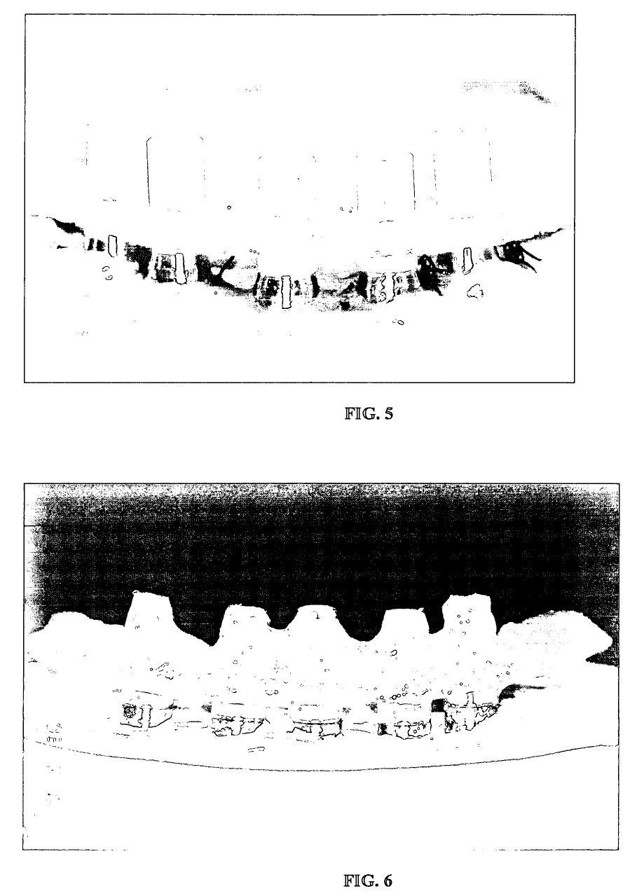

The frame component is again positioned on the waxing sleeves. Ideally the frame is horizontally leveled parallel to the interpupilary line and vertically positioned to allow for adequate dental hygiene (see FIG. 5).

Step 10:

Additional pattern resin is then allowed to flow into the area around the waxing sleeves to secure them to the frame component.

Step 11:

The waxing sleeves and the frame component are then removed from the implants as a single piece or unit. Following this step, the patient can be dismissed for the day (usually by 11:00 AM in the exemplary timeline).

Step 12:

The laboratory analogs of the implants are attached to the waxing sleeves and set in stone (see FIG. 6). This cast serves as an index to assess framework fit and will also be used later for articulator mounting after final jaw relation records are obtained.

Step 13:

The resin framework is sent to a dental laboratory for casting into metal alloy. The passivity of fit can be verified on the index cast and the framework can be sectioned and soldered if necessary.

B. DAY TWO

Step 14: Restorative appointment: 8:00 AM (exemplary timeline)

(a) The passive fit of the framework in the patient's mouth is confirmed.

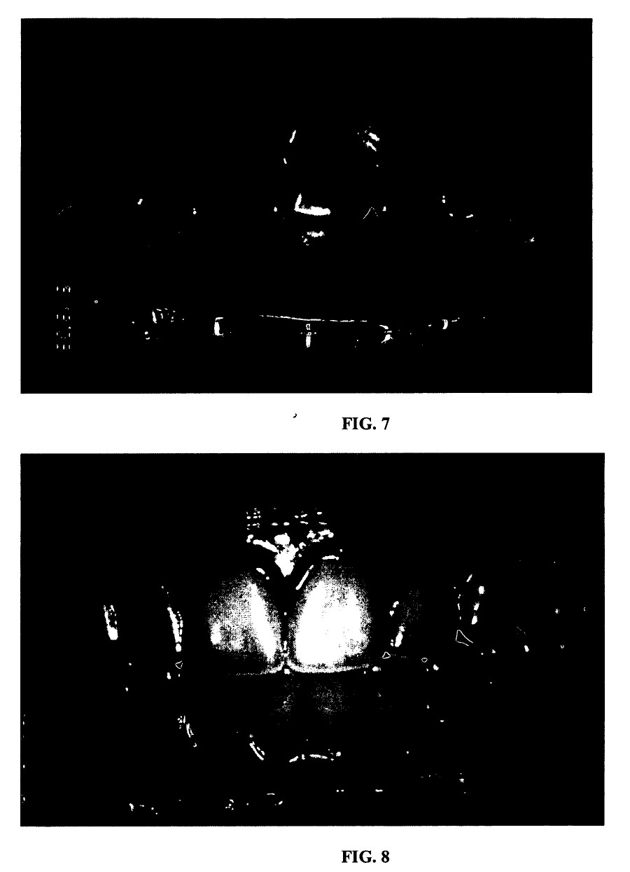

(b) A wax occlusion rim is attached to the frame and final jaw relation records are obtained (see FIG. 7).

(c) The mandibular cast is mounted and returned to the laboratory for tooth arrangement.

Step 15: Restorative appointment: 10:30 AM (exemplary timeline)

(a) Aesthetics, phonetics and occlusion are analyzed.

(b) The restoration is returned to the laboratory for final processing using fast-set, heat-cured acrylic resin.

Step 16: Restorative appointment: 2:00 PM (exemplary timeline)

(a) The final prosthesis is delivered after finishing and polishing (see FIG. 8).

(b) The prosthesis is mounted on the patient's jaw; normal surgical and denture follow-up protocols are recommended.

In summary, in the exemplary embodiment, the Branemark Novum (Nobel Biocare USA Yorba Linda, Calif.) provides the basis for the procedure that permits same day loading with a final fixed restorative prosthesis. The present invention provides for the efficient delivery of a final, fixed-detachable implant supported prosthesis in about two days using a unique pattern resin framework. The method described involves little modification of established surgical protocol, does not require additional armamentarium, and can be used with most implant systems. The pattern resin framework is easily modifiable and can accommodate almost any anatomic situation. The system can also compensate for less than perfect surgical implant placement and help to manage the restorative logistics of coordinating early implant loading.

While the above description contains much specificity, this should not be construed as a limitation on the scope of the invention, but rather as an exemplification of certain preferred or exemplary embodiments. Numerous other variations of the present invention are possible, and it is not intended herein to mention all of the possible equivalent forms or ramifications of this invention. Various changes may be made to the present invention without departing from the scope or spirit of the invention

1. A system for performing restorative dentistry on a subject, comprising:
(a) a diagnostic method, said diagnostic method comprising the steps of:
(i) taking maxillary and mandibular casts of said subject;
(ii) placing a resin frame over at least one of said casts, and wherein the dimensions of said frame substantially correspond to the dimensions of at least of said casts, and wherein said frame further comprises a plurality of apertures passing through the body of said frame;
(iii) creating a hole in said resin frame, wherein the location of said hole substantially corresponds to the central portion of said at least one cast; and
(b) a surgical method, said surgical method comprising the steps of:
(i) placing a first dental implant in the jaw said subject on which said restorative dentistry is being performed, and wherein said implant is centrally located on said jaw;
(ii) securing a waxing sleeve to said first implant;
(iii) placing said frame over said waxing sleeve and placing a plurality of dental implants in said subjects jaw using said apertures in said frame as a guide;
(iv) removing said frame from the subjects mouth and securing waxing sleeves to the remaining implants;
(v) placing said frame component back in the subject's mouth and securing said frame to said waxing sleeves to create a framework;
(vi) removing said framework from said subject;
(vii) casting said framework into a metal alloy;
(viii) mounting a dental prosthetic to said framework; and
(ix) mounting said prosthesis to said subject's jaw.
